(19) United States
(12) Patent Application Publication
(10) Pub. No.: US 2015/0072594 A1
(43) Pub. Date: Mar. 12, 2015

(54) METHOD FOR DETECTING A POLISHING COMPOUND AND RELATED SYSTEM AND COMPUTER PROGRAM PRODUCT

(71) Applicant: Apple Inc., Cupertino, CA (US)

(72) Inventors: Duco B. Pasmooij, San Francisco, CA (US); Kee Han Sim, Suzhou (CN); Christopher R. Fagan, Pacifica, CA (US)

(73) Assignee: Apple Inc., Cupertino, CA (US)

(21) Appl. No.: 14/022,116

(22) Filed: Sep. 9, 2013

(51) Int. Cl. B24B 55/00; B08B 13/00; G01N 21/64

(52) U.S. Cl. CPC B24B 55/00; G01N 21/64; B08B 13/00; G01N 2021/6497
USPC 451/6; 451/28; 451/64; 451/73

(57) ABSTRACT

Manufacturing methods are provided. A component may be polished to remove defects thereon. An identifier may be added to the polishing material employed to polish the component. A detector may detect the identifier. For example, the identifier may be a fluroescing material that may illuminate in the presence of a fluorescent light. A determining apparatus may determine a status of the component based on the presence or absence of the identifier. For example, the determining apparatus may determine that the component needs to be re-cleaned based on presence of the identifier. Related systems and computer program products are also provided.

### TECHNICAL FIELD

The present disclosure relates generally to polishing operations, and more particularly to detecting a polishing compound residue on a component and a related system and computer program product.

### BACKGROUND

Components employed to form various devices such as computing devices often undergo numerous manufacturing operations during the production thereof. Further, in some instances it may be desirable to perform certain finishing operations on the component after completion of the manufacturing operations. In this regard, finishing operations may improve the cosmetic appearance of the component or otherwise alter the appearance thereof

For example, some components may be produced by injection molding. However, the mold employed to form the component may cause the resulting component to include seam lines or tabs where the mold separates, where the material is injected, or at other locations. Accordingly, it may be desirable to remove the seams and tabs to improve the cosmetic appearance of the component.

However, processes employed to remove seam lines, tabs, and other defects or otherwise finish a component may leave behind residue. Such residue may affect any additional finishing operations performed on the component. For example, the residue may affect the ability of a paint to bind to the component. Cleaning operations may attempt to remove the residue, but such operations may not be entirely effective, particularly because it may not be possible to visually identify the residue.

Accordingly, improved methods for detecting the residue from finishing operations may be desirable.

### SUMMARY

Embodiments of the present disclosure relate to inspecting components for the presence of contaminants. By way of example, a polishing material employed to polish a component may remain on a component after the completion of a polishing operation. Even a cleaning operation may be insufficient to remove the polishing material. Further, presence of the polishing material may be difficult to visually detect, due to the polishing material defining a thin layer, which may be translucent or transparent.

Accordingly, an identifier may be added to the polishing material. A detector may be configured to detect the identifier. In some embodiments the identifier may be a fluorescing material. Accordingly, the detector may include a fluorescing light configured to illuminate the identifier. Thereby, illumination of the identifier may be detected.

Further, a determining apparatus may be configured to determine a status of the component based on the presence or absence of the identifier. For example, the determining apparatus may determine that the polishing material is present when the presence of the identifier is detected.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, assemblies, methods, and systems. These drawings in no way limit any changes in form and detail that may be made to the disclosure by one skilled in the art without departing from the spirit and scope of the disclosure.

FIG. 1 schematically illustrates a manufacturing system including manufacturing equipment and finishing equipment according to an example embodiment of the present disclosure;

FIG. 2 schematically illustrates a manufacturing system including manufacturing equipment comprising an injection molding apparatus and finishing equipment including a polishing apparatus, a cleaning apparatus, and a painting apparatus according to an example embodiment of the present disclosure;

FIG. 3 schematically illustrates a manufacturing system including the manufacturing and finishing equipment from FIG. 2 and a detector configured to detect an identifier in a polishing material and a determining apparatus configured to determine a status of a component based on the presence or absence of the identifier according to an example embodiment of the present disclosure;

FIG. 4 schematically illustrates a detector according to an example embodiment of the present disclosure;

FIG. 5 schematically illustrates a manufacturing method according to an example embodiment of the present disclosure; and

FIG. 6 schematically illustrates a block diagram of an electronic device according to an example embodiment of the present disclosure.

### DETAILED DESCRIPTION

Representative applications of systems, apparatuses, computer program products and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

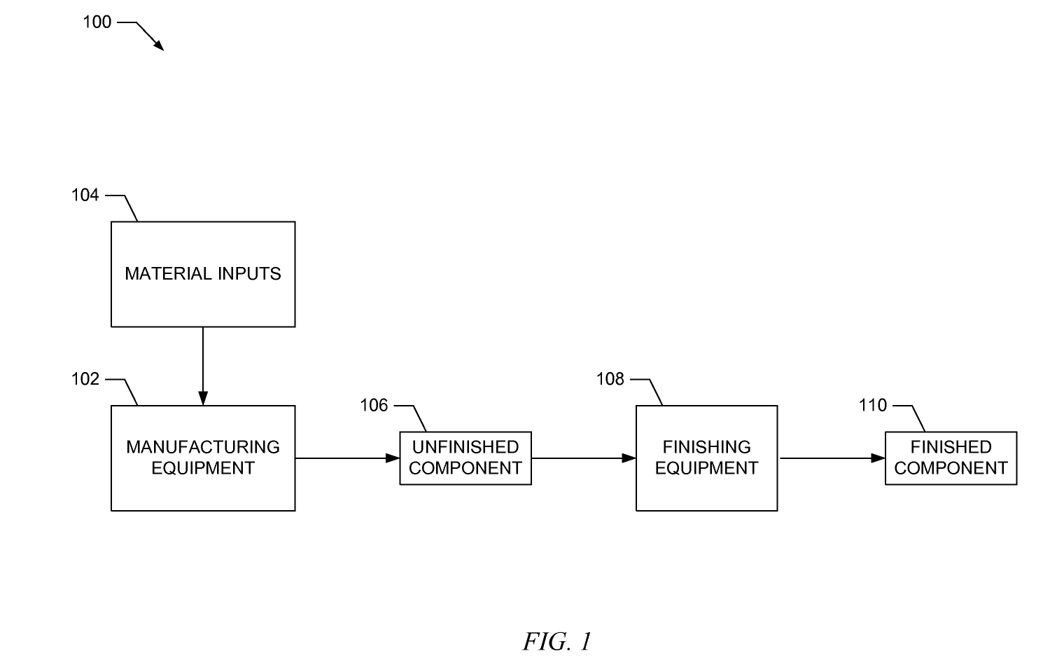

FIG. 1 illustrates a manufacturing system 100. As illustrated, the manufacturing system 100 may include manufacturing equipment 102 configured to receive material inputs 104 and perform one or more manufacturing operations thereon to produce an unfinished component 106. Note that a component, as used herein, refers to any embodiment of a part or whole of any apparatus or assembly. By way of example, a component may comprise a portion of a computing device, such as a housing therefore.

Optionally, the manufacturing system 100 may include finishing equipment 108. The finishing equipment 108 may perform one or more finishing operations on the unfinished component 106 to produce a finished component 110. For example, finishing operations may include polishing, cleaning, painting, anodizing, etc. depending on the type of material from which the component is formed and the desired end product.

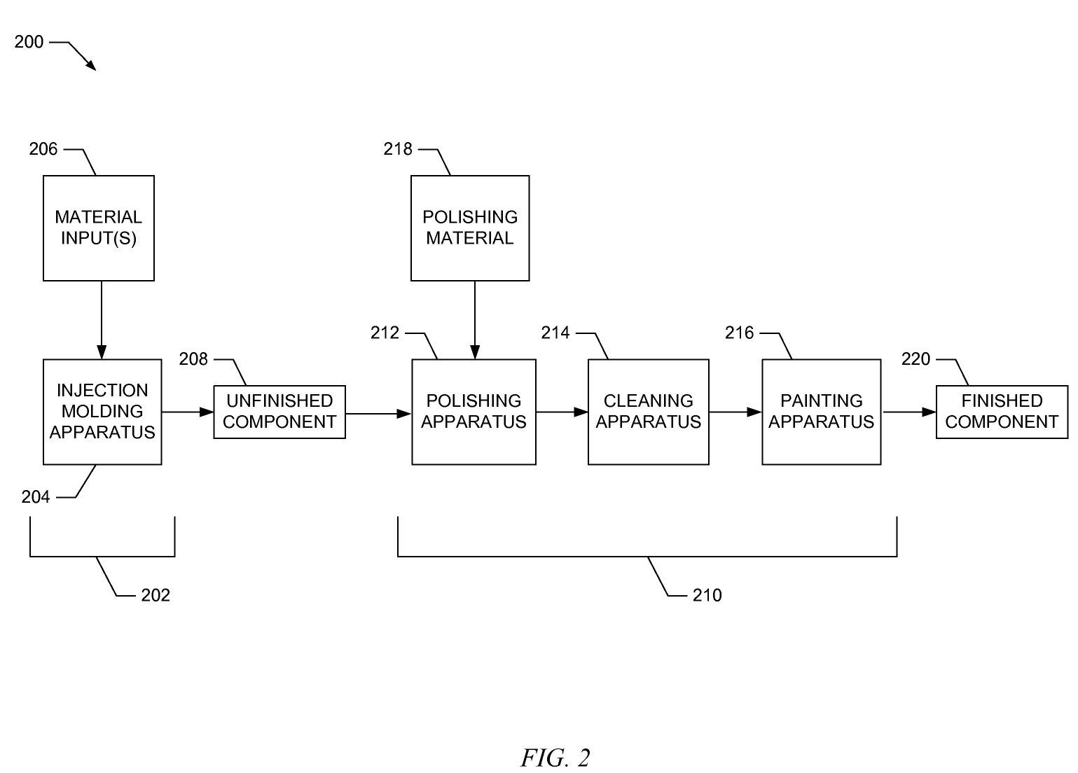

A more detailed illustration of a manufacturing system 200 is provided in FIG. 2. In this regard, the example embodiment of the manufacturing system 200 includes manufacturing equipment 202 comprising an injection molding apparatus 204. Briefly, the injection molding apparatus 204 is configured to receive one or more material inputs 206 in a mold. The material input 206 may comprise a liquid prior to entering the injection molding apparatus 204, or the material input may be heated in the injection molding apparatus to a liquid state. Thereafter, the material input 206 is solidified in the injection molding apparatus 204 such that the material takes the shape of a mold in which the material input is received. An unfinished component 208 may then be retrieved from the mold.

Note, however, that various alternative or additional manufacturing equipment and corresponding operations may be employed. For example, the unfinished component may be formed from various milling, drilling, computer numerical control, welding, and other operations in other embodiments. However, regardless of the method and equipment employed to manufacture the component, certain finishing operations may thereafter be desirable.

In this regard, the unfinished component 208 may include certain defects. For example, in embodiments of the manufacturing system 200 including the injection molding apparatus 204, the unfinished component 208 may include a seam thereon corresponding to a location at which parts of the mold separate. However, various other defects may exist such as a rough surface finish.

Accordingly, the unfinished component 208 may be directed to finishing equipment 210 that performs finishing operations thereon. In the illustrated embodiment, the finishing equipment 210 comprises a polishing apparatus 212, a cleaning apparatus 214, and a painting apparatus 216. However, the finishing equipment 210 may include various additional or alternative apparatuses in other embodiments.

The polishing apparatus 212 may be configured to polish the unfinished component 208 with a polishing material 218. Polishing operations may be employed to blend the geometry of a component to meet desired specifications. Example embodiments of a polishing material 218 may be wax, oil, and/or water based. Further, the polishing material 218 may include an abrasive (e.g., aluminum oxide). However, various other embodiments of polishing materials, which may also be referred to as polishing compounds or polishing consumables, may be employed depending on the type of material employed to form the unfinished component 208.

The polishing apparatus 212 may include a polishing wheel or other tool which may move with respect to the unfinished component 208 to abrade the unfinished component with the polishing material 218. For example, the polishing wheel may employ rotary, linear, orbital, or random orbital motion to produce relative motion with respect to the unfinished component 208. Accordingly, the polishing apparatus 212 may abrade the unfinished component 208 to remove a seam thereon or other defects using the polishing material 218.

However, in order to remove the polishing material 218 from the unfinished component 208 after completing the polishing operation, the unfinished component may be directed to the cleaning apparatus 214, which may be configured to clean the unfinished component. In this regard, the unfinished component 208 may include contaminants thereon such as a release agent configured to facilitate removal of the unfinished component from the mold, machining lubricant, and/or the polishing material 218 applied to the unfinished component during the polishing operation. Accordingly, the cleaning apparatus 214 may employ fluids (e.g., water, soap, solvent, etc.), heat, and/or physical contact (e.g., with a brush) to remove the contaminants from the unfinished component 208.

Optionally, various additional or alternative finishing operations may be performed on the unfinished component 208. For example, the painting apparatus 216 may be employed to paint the unfinished component 208 and thereby produce a finished component 220. In this regard, removal of contaminants may assist in bonding the paint to the unfinished component 208 and/or performing other operations on the unfinished component such as anodization. Further, removal of the contaminants may reduce the potential for adhesion of additional contaminants on the component and/or undesirable chemical interactions during operations performed later on the component.

However, Applicants have determined that certain contaminants may not be removed by cleaning apparatus from components in all instances. In this regard, for example, it may be difficult to remove polishing materials from components. Further, polishing materials may be difficult to detect visually. By way of further example, a wax residue from a polishing material may substantially blend in with the component and thereby it may be very difficult to visually distinguish the wax residue from the base material of the component.

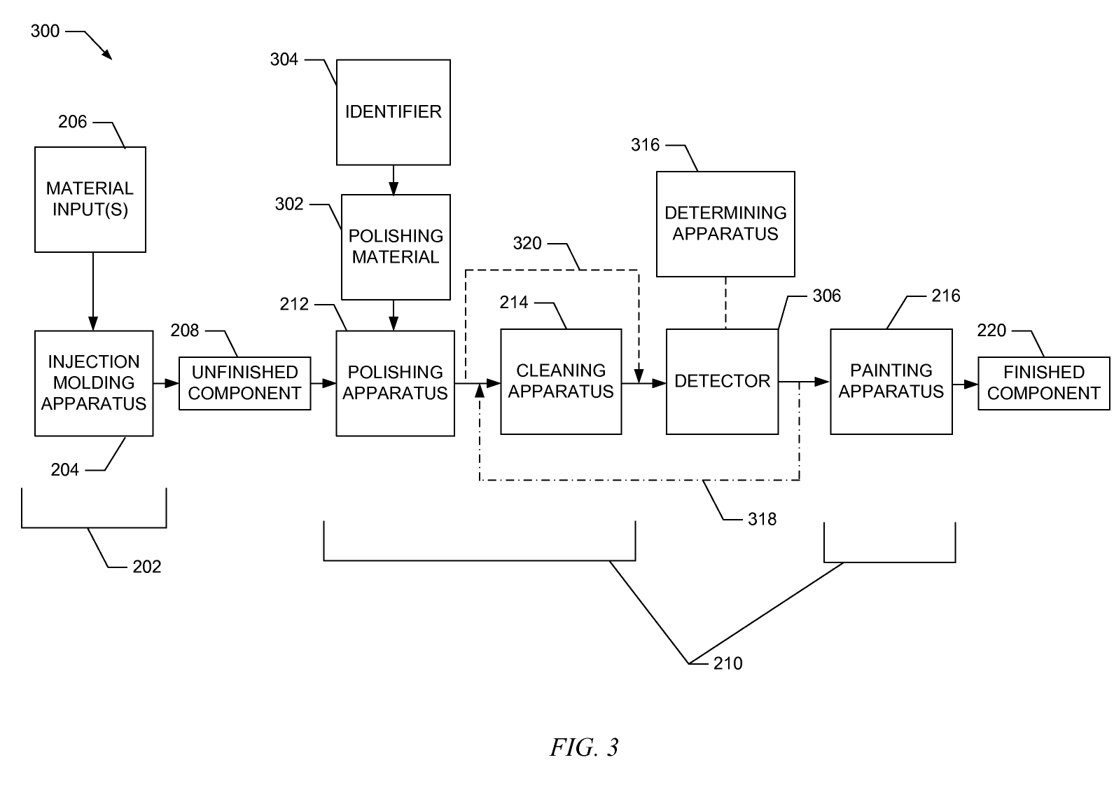

Accordingly, embodiments of the present disclosure are configured to address the above-noted problems and provide other benefits as described elsewhere herein. In this regard, FIG. 3 illustrates a manufacturing system 300 according to an additional example embodiment of the present disclosure. The embodiment of the manufacturing system 300 illustrated in FIG. 3 includes the manufacturing equipment 202 and the finishing equipment 210 described above with respect to FIG. 2.

Accordingly, the manufacturing equipment 202 and the finishing equipment 210 will not be described in detail. Briefly, however, the manufacturing equipment 202 may include the injection molding apparatus 204. Further, the finishing equipment 210 may include the polishing apparatus 210, the cleaning apparatus 212, and the painting apparatus 214. However, as may be understood, various additional or alternative manufacturing equipment and finishing equipment may be employed in other embodiments. In this regard, embodiments of the present disclosure may be employed in any system to detect the presence or absence of a residue on a component, as described in detail below.

Accordingly, in the manufacturing system 300 illustrated in FIG. 3, an unfinished component 208 may be directed to a polishing apparatus 212. The unfinished component 208 may be produced from material inputs 206 by manufacturing equipment 202, such as the illustrated injection molding apparatus 204. The polishing apparatus 212 may be configured to polish the unfinished component 208 with a polishing material 302. However, the embodiment of the manufacturing system 300 illustrated in FIG. 3 differs from the embodiment of the manufacturing system 200 illustrated in FIG. 2 in that the polishing material 302 may comprise an identifier 304. In some embodiments the identifier 304 may define less than about twenty percent of the mass of the polishing material 302. As described below, the identifier 304 may be employed to detect presence or absence of the polishing material 302 on the unfinished component 208.

In this regard, the manufacturing system 300 may further comprise a detector 306 configured to detect a presence or an absence of the identifier 304 on a component such as the unfinished component 208. Note that although the detector 306 is generally described herein as detecting the presence or absence of the identifier 304 on the unfinished component 208, the detector may be employed to detect the presence or the absence of the identifier on various other components in any state (e.g., unfinished or finished).

The detector 306 may be particularly configured to detect the identifier 304 based on the embodiment of the identifier employed. In this regard, as noted above, it may be difficult to visually detect residue from existing embodiments of polishing materials on components. Accordingly, the identifier 304 may be added to the polishing material 302 to facilitate detection thereof

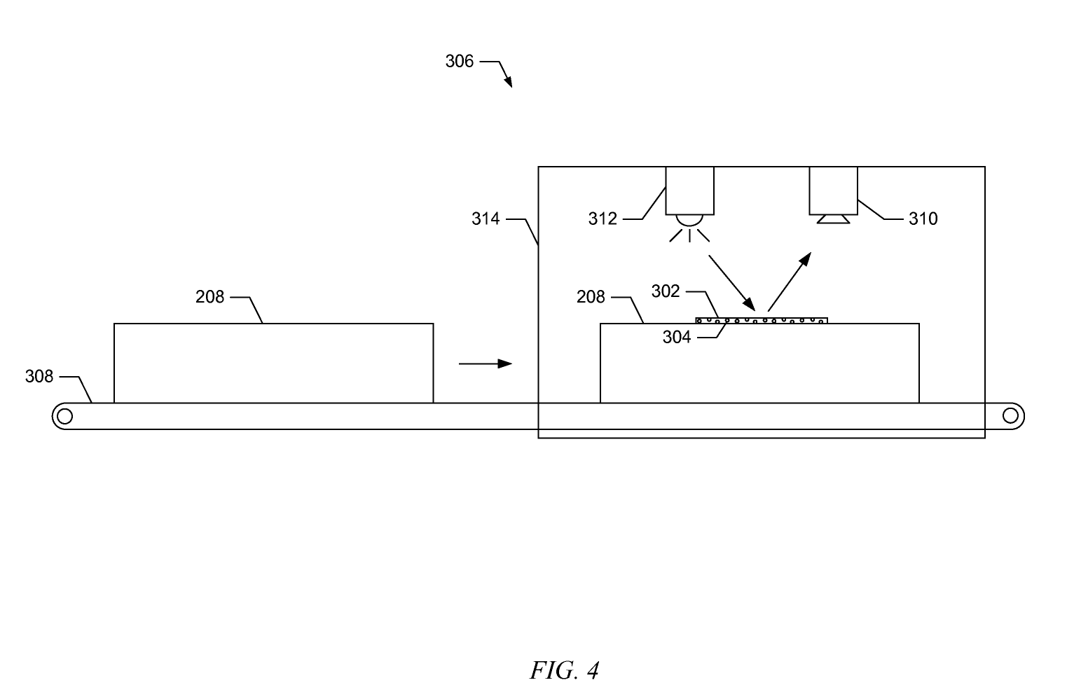

FIG. 4 illustrates an example embodiment of the detector 306. As illustrated, unfinished components 208 may be directed to the detector 306 by a conveyor 308. However, the unfinished component 208 may be transported to the detector 306 in various other manners in other embodiments. As illustrated, the detector 306 may comprise a sensor 310 configured to detect a presence or an absence of the identifier 304 on the unfinished component 208.

In some embodiments the sensor 310 may comprise a camera (e.g., a charge-coupled device (CCD) camera) configured to capture one or more images of the unfinished component 208. Note that although one sensor 310 is employed in the illustrated embodiment, multiple sensors may be employed in other embodiments in order to capture images of the unfinished component 208 from multiple angles. Alternatively or additionally, the position of the sensor 310 with respect to the unfinished component 208 may be altered such that the sensor may capture images of the unfinished component from multiple angles. Thus, for example, in one embodiment the sensor 310 may move, whereas in another embodiment the unfinished component 208 may be moved to allow for capturing of images from multiple perspectives. Thereby, for example, in some embodiments substantially the entirety of the exterior of the unfinished component 208 may be examined by the detector 306.

In some embodiments the sensor 310 may be configured to capture images of the unfinished component 208 in the visible spectrum. However, as noted above, polishing materials may be difficult to detect. In this regard, some polishing materials may include a coloring agent, which may allow for identification thereof prior to use. Although the coloring agent initially provides the polishing material with a visually distinctive color, the polishing material may be difficult to detect after being employed to polish the unfinished component 208. For example, the coloring agent may comprise a plurality of particles. During polishing and/or any subsequent cleaning operation of the unfinished component 208, the particles may be removed from the unfinished component despite some of the polishing material remaining thereon. In this regard, in some embodiments the particles may define a relatively large dimension (e.g., about 1 micron diameter or greater), such that the particles may not be retained in the polishing material when the thickness of the layer of the polishing material on the unfinished component 208 decreases below the dimension of the particles.

Thus, in one embodiment of the present disclosure, the identifier 304 may comprise colored particles that are relatively small. For example, the identifier 304 may comprise nanoparticles defining a color that differs from a color of the material of the unfinished component 208. Thereby, even when the polishing material 302 is reduced to a relatively small thickness on the unfinished component 208, for example due to polishing and/or cleaning operations performed thereon, the particles of the identifier 304 may remain therein. Alternatively, the identifier 304 may be provided in a non-particulate form such that issues with respect to particle dimensions are avoided.

Accordingly, the sensor 310 may visually detect the identifier 304. In one embodiment the sensor 310 may employ ambient light to detect the identifier 304. In another embodiment, as illustrated in FIG. 4, the detector 306 may further comprise an emitter 312. The emitter 312 may emit light which may illuminate the unfinished component 208. Thus, the emitter 312 may comprise an incandescent bulb, light emitting diode, compact fluorescent light (CFL) bulb, or other source of visible light. Thereby, the sensor 310 may detect the identifier 304 as illuminated by the emitter 312.

In another embodiment detector 306 may be configured to detect the identifier 304 via manners and methods outside of the visible spectrum. In this regard, in one embodiment the identifier 304 may comprise a fluorescing material (e.g., an ultraviolet (UV) tracer). Accordingly, the detector 306 may be configured to detect fluorescence of the fluorescing identifier 304. For example, the emitter 312 may be configured to emit ultraviolet light at the unfinished component 308 and the sensor 310 may be configured to detect fluorescence (e.g., by detecting a radiant flux emitted by the fluorescent material). In this regard, the fluorescence may contrast with a color of the base material to provide for relatively easy detection by the detector 306.

In some embodiments the emitter 312 and the sensor 310 may be positioned in an enclosure 314. Further, the unfinished component 308 may be received therein during detection of the identifier 304. The enclosure 314 may function to substantially block ambient light to provide controlled conditions for detection of the identifier 304. Accordingly issues with respect to fluctuations in ambient light affecting detection of the identifier 304 may be avoided.

As further illustrated in FIG. 3, the manufacturing system 300 may include a determining apparatus 316. The determining apparatus 316 may be configured to determine a status of the unfinished component 208 based on the presence or absence of the identifier 304, as detected by the detector 306. The determining apparatus 316 may determine various different embodiments of statuses of the unfinished component 208, as described hereinafter. For example, in one embodiment the determining apparatus 316 may determine whether the polishing material 302 is present. In this regard, presence of the identifier 304, as detected by the detector 306 indicates that the polishing material 302 is present.

In another embodiment the determining apparatus 316 may be configured to determine at least one of a size of an area of the polishing material 302 on the unfinished component 208 and a size of an area on the unfinished component without the polishing material. In this regard, the area over which the detector 306 detects the indicator 304 on the unfinished component 208 may correspond to the area with the polishing material 302 thereon, whereas an area on the unfinished component where the indicator is not detected may correspond to the area without the polishing material. In order to accurately determine the size of the areas with and/or without the polishing material 302, the sensor 310 may only capture images of the unfinished component 208, or the determining apparatus 316 may ignore portions of captured images not including the unfinished component 208. The areas on the unfinished component 208 including the polishing component 302 and/or not including the polishing component may be determined using computer vision methods such as edge detection and region extraction for the detected identifier 304. In another embodiment the amount of the polishing material 302 on the unfinished component 208 may be determined based on the detected radiant flux emitted by the identifier 304. Accordingly, the size, shape, and amount of the polishing material 302 on the component may be detected in various embodiments.

In one embodiment the manufacturing system 300 may include the cleaning apparatus 214. As illustrated, the cleaning apparatus 214 may clean the unfinished component 208 after the polishing apparatus 212 polishes the unfinished component and before the detector 306 detects the presence or the absence of the identifier 304 on the unfinished component. In this embodiment the determining apparatus 316 may be configured to determine whether to re-clean the unfinished component 208, as indicated by path 318. In this regard, the determining apparatus 316 may determine that re-cleaning is needed when any of the identifier 304 is detected, or when the amount of the identifier (e.g., the area of the identifier on the unfinished component 208) exceeds a threshold value. Further, in some embodiments the determining apparatus 316 may direct the cleaning apparatus, or a manual laborer, to spot clean the particular areas on the unfinished component 208 at which the polishing material 302 is present. Accordingly, the cleaning process may be iteratively repeatedly until the unfinished component 208 is cleaned to a desired extent.

In another embodiment the determining apparatus 316 may be configured to identify a source of the component based on the identifier 304. In this regard, for example, the identifier 304 in the polishing material 302 may be a unique identifier. Thus, for example, in some instances a plurality of manufacturers (e.g., suppliers) may manufacture the unfinished components 208 or the finished components 220. Each of the manufacturers may be supplied with a polishing material 302 including a unique identifier 304.

Thereby, the identifier 304 detected by the detector 306 may be employed to determine the source of the unfinished component 208 or the finished component 220. For example, each identifier 304 may emit a unique wavelength of light when exposed to ultraviolet radiation. Accordingly, based on the detected identifier 304, the determining apparatus 316 may determine the manufacturer of the component. This may be useful in determining the identity of the manufacturer of a component for quality control purposes or for other purposes such as determining which manufacturer leaked a component to the public when the manufacturers were supposed to keep the component secret.

In this embodiment, in order to ensure that some of the identifier 304 remains on the component for detection at a later time, the cleaning apparatus 214 may not be employed, as indicated by path 320. Further, in some embodiments, the painting apparatus 216 may paint a clear, translucent, or transparent coat of paint on the component that may allow for detection of the identifier 304 therethrough while retaining the identifier thereon in a substantially permanent manner. However, in other embodiments the cleaning apparatus 214 may be employed and any remaining residue from the polishing material 302 may include a sufficient amount of the identifier 304 for detection by the detector 306. The identifier 304 may be detected in the manners described above. Alternatively, the component may be subjected to a cleaning operation whereby any contaminants recovered from the cleaning operation are analyzed by the detector, and then the determining apparatus may determine the identity of the manufacturer.

Note that embodiments of the present disclosure are generally described herein as being employed during an in-line manufacturing process. However, the methods and equipment disclosed herein may be employed for setting up a manufacturing line (e.g., to ensure that a component is completely and properly cleaned), as a development tool to test cleaning processes, as a guide for determining how much cleaning a component may require, or for various other purposes such as determination of the manufacturer of a component as described above.

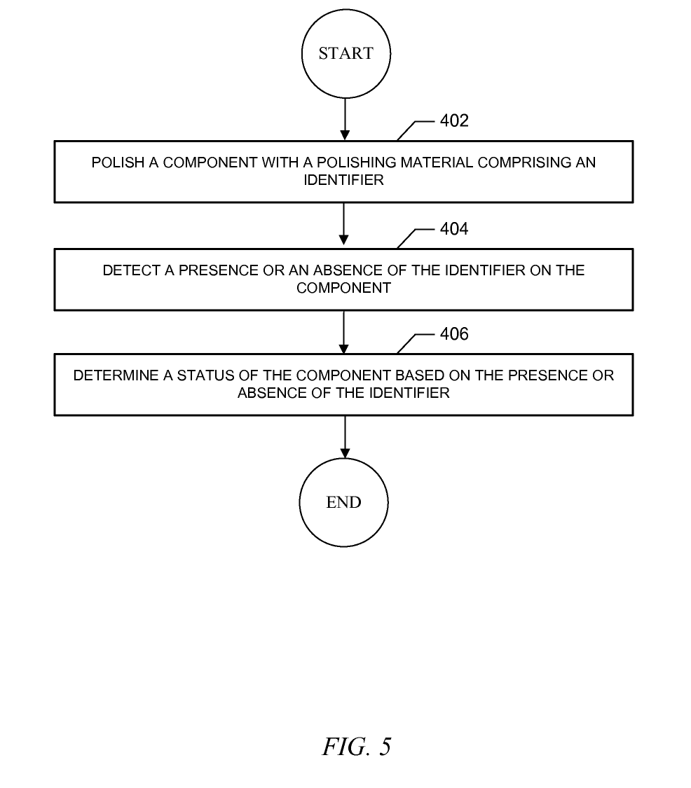

A related manufacturing method is also provided. As illustrated in FIG. 5, the method may include polishing a component with a polishing material comprising an identifier at operation 402. Further, the method may include detecting a presence or an absence of the identifier on the component at operation 404. The method may additionally include determining a status of the component based on the presence or absence of the identifier at operation 406.

In some embodiments the method may further comprise cleaning the component after polishing the component at operation 402. Cleaning the component may be conducted before detecting the presence or the absence of the identifier on the component at operation 404. In this embodiment determining the status of the component based on the presence or absence of the identifier at operation 406 may comprise determining whether to re-clean the component.

In some embodiments determining the status of the component based on the presence or absence of the identifier at operation 406 may comprise determining at least one of a size of an area of the polishing material on the component and a size of an area on the component without the polishing material. In another embodiment determining the status of the component based on the presence or absence of the identifier at operation 406 may comprise identifying a source of the component based on the identifier. In one embodiment the identifier may comprise a fluorescing material. In this embodiment detecting the presence or the absence of the identifier on the component at operation 402 may comprise illuminating the component with ultraviolet light and detecting a radiant flux emitted by the fluorescent material.

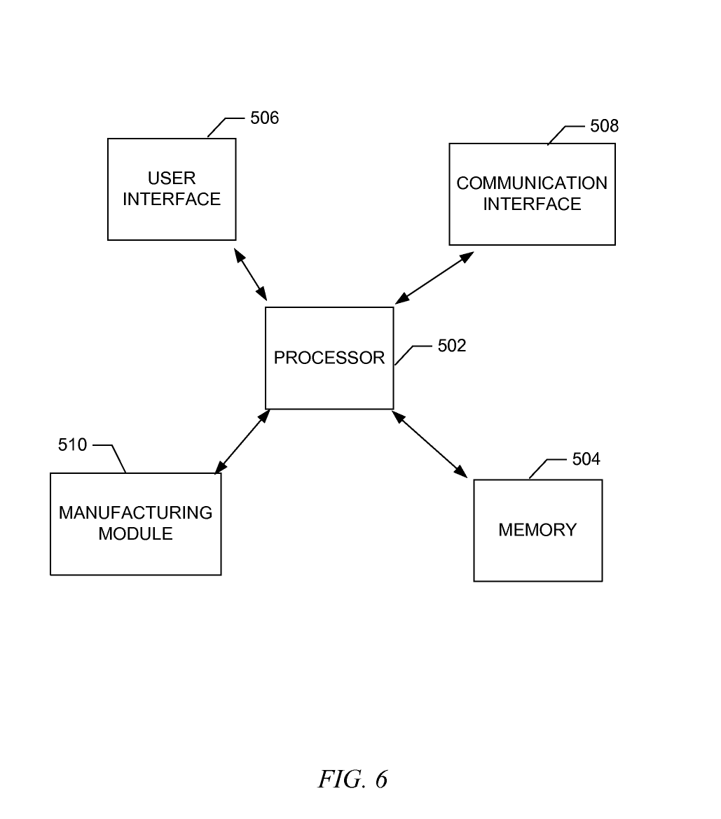

FIG. 6 is a block diagram of an electronic device 500 suitable for use with the described embodiments. In one example embodiment the electronic device 500 may be embodied in or as a controller configured for controlling operations performed in the manufacturing and inspection as disclosed herein. In this regard, the electronic device 500 may be configured to control or execute the above-described manufacturing and inspecting operations performed by the detector 306, the determining apparatus 316, and/or other apparatuses.

The electronic device 500 illustrates circuitry of a representative computing device. The electronic device 500 may include a processor 502 that may be microprocessor or controller for controlling the overall operation of the electronic device 500. In one embodiment the processor 502 may be particularly configured to perform the functions described herein relating to manufacturing and inspecting components. The electronic device 500 may also include a memory device 504. The memory device 504 may include non-transitory and tangible memory that may be, for example, volatile and/or non-volatile memory. The memory device 504 may be configured to store information, data, files, applications, instructions or the like. For example, the memory device 504 could be configured to buffer input data for processing by the processor 502. Additionally or alternatively, the memory device 504 may be configured to store instructions for execution by the processor 502.

The electronic device 500 may also include a user interface 506 that allows a user of the electronic device 500 to interact with the electronic device. For example, the user interface 506 can take a variety of forms, such as a button, keypad, dial, touch screen, audio input interface, visual/image capture input interface, input in the form of sensor data, etc. Still further, the user interface 506 may be configured to output information to the user through a display, speaker, or other output device. A communication interface 508 may provide for transmitting and receiving data through, for example, a wired or wireless network such as a local area network (LAN), a metropolitan area network (MAN), and/or a wide area network (WAN), for example, the Internet.

The electronic device 500 may also include a manufacturing module 510. The processor 502 may be embodied as, include or otherwise control the manufacturing module 510. The manufacturing module 510 may be configured for controlling or executing the manufacturing and inspecting operations as discussed herein.

In this regard, for example, in one embodiment a computer program product comprising at least one computer-readable storage medium having computer-executable program code portions stored therein is provided. The computer-executable program code portions, which may be stored in the memory device 504, may include program code instructions for polishing a component with a polishing material comprising an identifier, program code instructions for detecting a presence or an absence of the identifier on the component, and program code instructions for determining a status of the component based on the presence or absence of the identifier.

The computer program product may further comprise program code instructions for cleaning the component after polishing the component and before detecting the presence or the absence of the identifier on the component. The program code instructions for determining the status of the component based on the presence or absence of the identifier may comprise program code instructions for determining whether to re-clean the component. In another embodiment the program code instructions for determining the status of the component based on the presence or absence of the identifier may comprise program code instructions for determining at least one of a size of an area of the polishing material on the component and a size of an area on the component without the polishing material. In an additional embodiment the program code instructions for determining the status of the component based on the presence or absence of the identifier may comprise program code instructions for identifying a source of the component based on the identifier. Further, the program code instructions for detecting the presence or the absence of the identifier on the component may comprise program code instructions for illuminating the component with ultraviolet light and detecting a radiant flux emitted by the identifier.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A manufacturing method, comprising:
polishing a component with a polishing material comprising an identifier; and
detecting a presence or an absence of the identifier on the component; and
determining a status of the component based on the presence or absence of the identifier.

2. The manufacturing method of claim 1, further comprising cleaning the component after polishing the component and before detecting the presence or the absence of the identifier on the component.

3. The manufacturing method of claim 2, wherein determining the status of the component based on the presence or absence of the identifier comprises determining whether to re-clean the component.

4. The manufacturing method of claim 1, wherein determining the status of the component based on the presence or absence of the identifier comprises determining at least one of a size of an area of the polishing material on the component and a size of an area on the component without the polishing material.

5. The manufacturing method of claim 1, wherein determining the status of the component based on the presence or absence of the identifier comprises identifying a source of the component based on the identifier.

6. The manufacturing method of claim 1, wherein the identifier comprises a fluorescing material.

7. The manufacturing method of claim 6, wherein detecting the presence or the absence of the identifier on the component comprises illuminating the component with ultraviolet light and detecting a radiant flux emitted by the fluorescent material.

8. A manufacturing system, comprising:
a polishing apparatus configured to polish a component with a polishing material comprising an identifier;
a detector configured to detect a presence or an absence of the identifier on the component; and
a determining apparatus configured to determine a status of the component based on the presence or absence of the identifier.

9. The manufacturing system of claim 8, further comprising a cleaning apparatus configured to clean the component after the polishing apparatus polishes the component and before the detector detects the presence or the absence of the identifier on the component.

10. The manufacturing system of claim 9, wherein the determining apparatus is configured to determine whether to re-clean the component.

11. The manufacturing system of claim 8, wherein the determining apparatus is configured to determine at least one of a size of an area of the polishing material on the component and a size of an area on the component without the polishing material.

12. The manufacturing system of claim 8, wherein the determining apparatus is configured to identify a source of the component based on the identifier.

13. The manufacturing system of claim 8, wherein the identifier comprises a fluorescing material.

14. The manufacturing system of claim 13, wherein the detector is configured to emit ultraviolet light at the component and detect a radiant flux emitted by the fluorescent material.

15. A computer program product comprising at least one computer-readable storage medium having computer-executable program code portions stored therein, the computer-executable program code portions comprising:
program code instructions for polishing a component with a polishing material comprising an identifier; and
program code instructions for detecting a presence or an absence of the identifier on the component; and
program code instructions for determining a status of the component based on the presence or absence of the identifier.

16. The computer program product of claim 15, further comprising program code instructions for cleaning the component after polishing the component and before detecting the presence or the absence of the identifier on the component.

17. The computer program product of claim 16, wherein the program code instructions for determining the status of the component based on the presence or absence of the identifier comprise program code instructions for determining whether to re-clean the component.

18. The computer program product of claim 15, wherein the program code instructions for determining the status of the component based on the presence or absence of the identifier comprise program code instructions for determining at least one of a size of an area of the polishing material on the component and a size of an area on the component without the polishing material.

19. The computer program product of claim 15, wherein the program code instructions for determining the status of the component based on the presence or absence of the identifier comprise program code instructions for identifying a source of the component based on the identifier.

20. The computer program product of claim 15, wherein the program code instructions for detecting the presence or the absence of the identifier on the component comprise program code instructions for illuminating the component with ultraviolet light and detecting a radiant flux emitted by the identifier.
